(19) United States
(12) Patent Application Publication
(10) Pub. No.: US 2014/0122645 A1
(43) Pub. Date: May 1, 2014

(54) METHOD AND SYSTEM FOR AUTOMATIC AGNOSTIC PROVISIONING OF A COMPUTING DEVICE

(71) Applicant: OpenPeak Inc., Boca Raton, FL (US)

(72) Inventors: John R. Brown, Boynton Beach, FL (US); Robert M. Dare, Sunrise, FL (US)

(21) Appl. No.: 14/059,563

(22) Filed: Oct. 22, 2013

Related U.S. Application Data
(60) Provisional application No. 61/718,301, filed on Oct. 25, 2012.

(51) Int. Cl. H04L 29/08

(52) U.S. Cl. CPC H04L 67/02
USPC 709/217

(57) ABSTRACT

A method and system for automatic agnostic provisioning of a computing device is described herein. The method can include the steps of generating a profile that establishes a level of management and operation for a particular user and identifying a plurality of computing devices that are associated with the user. The method can also include the step of tailoring content to be delivered to the computing devices based on the characteristics of the computing devices and the generated profile such that a substantially consistent level of management and operation is maintained for the user across the plurality of computing devices dependent on the characteristics of the computing devices.

### CROSS-REFERENCE TO RELATED APPLICATIONS

This patent application claims priority to U.S. Patent Application No. 61/718,301, filed on Oct. 25, 2012, which is incorporated herein by reference in its entirety.

### FIELD OF TECHNOLOGY

The present description relates to systems and methods for provisioning computing devices and updating such provisioning for newer versions of such devices or for different devices.

### BACKGROUND

The time when an entire workforce carried a standard mobile device easily and homogeneously managed by a mobile device management system has passed. Today, it is necessary for mobile device management systems to address and accommodate the increasingly diverse enterprise- and employee-owned devices spanning multiple operating systems and product generations. This diversity also expands to hardware on the devices, as one model may be equipped with two cameras and relatively large amounts of memory, while another may not have a camera and may include a much smaller storage capacity.

As is known, many enterprises may wish to manage the mobile devices owned or carried by their employees or associates. As part of this management, certain default settings or configurations may be imposed on the mobile devices, and specific content may be pushed to the devices, as well. Unfortunately, the numerous differences between the various mobile devices that may be managed complicate this process. Moreover, if an employee or associate upgrades to a different model, some of the initial configurations, settings or content intended for the previous model may not be applicable to the new mobile device. As such, it may be necessary for an administrator to intervene and manually re-configure the configurations, settings and content for the new device.

### SUMMARY

A method of automatic agnostic provisioning of a computing device is described herein. Agnostic provisioning refers to a process in which computing devices that include different hardware or software features are provisioned with content to maintain a consistent user experience as the user deploys new or updated computing devices, depending on the capabilities of the devices or some other factors, like a user profile. In one arrangement, the method can include the step of receiving a first fingerprint of a first computing device in which the first computing device may be associated with a first user. The first fingerprint can provide an inventory of the first computing device, and the inventory may include operational characteristics of the first computing device and information related to an identity of the first user. The method may also include the step of determining first content to be delivered to the first computing device. The first content may be based on the received first fingerprint such that the first content is based on the operational characteristics of the first computing device and a profile that is established for the first user. The first content may be sent and applied to the first computing device.

A second fingerprint of a second computing device that may also be associated with the first user may be received. The second fingerprint can provide an inventory of the second computing device, and the inventory of the second computing device may include operational characteristics of the second computing device and information related to the identity of the first user. The method can further include the step of determining second content to be delivered to the second computing device. The second content may be based on the received second fingerprint such that the second content is based on operational characteristics of the second computing device and the profile that is established for the first user. The second content can be sent to and applied to the second computing device.

As an example, the operational characteristics of the first or second computing device may include one or more of the following: memory resources; processing capabilities; current version or type of operating system; installed applications; hardware assets and their characteristics; framework minimum and maximum deployment versions; or communication characteristics. As another example, the profile that is established for the first user may be based on an organizational function assigned to the first user. In one arrangement, the first computing device may include a first operating system, and the second computing device may include a second operating system.

The method can also include the step of receiving a third fingerprint from the second computing device in which the third fingerprint can provide an updated inventory of the second computing device. As an example, the third fingerprint can be received on a periodic basis or based on an event. The method may also include the steps of determining updated content to be delivered to the second computing device in which the updated content is based on the received third fingerprint and sending the updated content to the second computing device. The updated content may be based on operational characteristics of the second computing device and the profile that is established for the first user. As another example, the first content and the second content mentioned above may include applications, settings or configurations that are to be applied to the first and second computing devices.

Another method for automatic agnostic provisioning of a computing device is described herein. The method can include the step of sending a first fingerprint of a first computing device. The first computing device may be associated with a first user, and the first fingerprint may provide an inventory of the first computing device. The inventory may include operational characteristics of the first computing device and information related an identity of the first user.

The method can also include the step of receiving first content at the first computing device. The first content may be based on the first fingerprint such that the first content is based on the operational characteristics of the first computing device and a profile that is established for the first user. The method can further include the step of sending a second fingerprint of a second computing device that is also associated with the first user. The second fingerprint may provide an inventory of the second computing device, and the inventory of the second computing device may include operational characteristics of the second computing device and information related to the identity of the first user. Second content can be received at the second computing device. The second content may be based on the received second fingerprint such that the second content is based on operational characteristics of the second computing device and the profile that is established for the first user.

As an example, the profile that is established for the first user may be based on an organizational function assigned to the first user. As another example, the first and second computing devices may include different operating systems.

Another method of automatic agnostic provisioning of a computing device is described herein. The method can include the step of generating a profile that may establish a level of management and operation for a particular user. This profile may be predetermined and may apply to an individual or a group of users and can determine the types of content available to a user, such as applications, confidential business information, settings or configurations applied to that user's device. The method can further include the step of identifying a plurality of computing devices that are associated with the user. In addition, content to be delivered to the computing devices can be tailored based on the characteristics of the computing devices and the generated profile such that a substantially consistent level of management and operation is maintained for the user across the plurality of computing devices dependent on the characteristics of the computing devices.

The method can also include the step of receiving a fingerprint from each of the plurality of computing devices in which the fingerprint identifies the user and the characteristics of the computing devices. The method can further include the steps of receiving an update fingerprint for one of the computing devices and sending update content to the computing device from which the update fingerprint was received.

As an example, the characteristics of the computing devices may include one or more of the following: memory resources; processing capabilities; current version or type of operating system; installed applications; hardware assets; framework minimum and maximum deployment versions; or communication characteristics. As another example, the profile that is generated for the user may be based on an organizational function assigned to the user. In one embodiment, the content may include applications, settings or configurations that are to be applied to the computing devices. Moreover, identifying the plurality of computing devices that are associated with the user may include successively identifying the plurality of computing devices such that some time exists between identifications of the computing devices.

Yet another method of automatic agnostic provisioning of a computing device is described herein. The method can include the step of receiving a first fingerprint of a computing device in which the computing device is associated with a user. The first fingerprint may provide a first inventory of the computing device, and the first inventory can include operational characteristics of the computing device and information related to an identity of the user. First content to be delivered to the computing device can be determined in which the first content can be based on the received first fingerprint such that the first content is based on the operational characteristics of the computing device and a profile that is established for the user. The first content can be sent to the computing device.

An update fingerprint of the computing device can be received in which the update fingerprint can provide an updated inventory of the computing device. The updated inventory of the computing device may include updated operational characteristics of the computing device. Updated content to be delivered to the computing device can be determined in which the updated content is based on the received update fingerprint such that the updated content is based on the updated inventory and the profile that is established for the user. The updated content can be sent to the computing device.

As an example, the updated inventory can further include information related to the identity of the user. As another example, the profile that is established for the user may be based on an organizational function assigned to the user, and the update fingerprint may be received based on a predetermined periodicity or based on a predetermined event.

Another method of automatic agnostic provisioning of a computing device is described herein. The method can include the steps of generating a profile that establishes a level of management and operation for a particular user and identifying a computing device that is associated with the user. The method can also include the step of tailoring content to be delivered to the computing device based on the characteristics of the computing device and the generated profile such that a substantially consistent level of management and operation is maintained for the user for the computing device when the computing device is updated, dependent on updated characteristics of the computing device. In one embodiment, the updated characteristics may be related to updated software features or updated hardware features.

A system for automatic agnostic provisioning of a computing device is described herein. The system can include an interface that may be configured to receive communications from and transmit communications to a plurality of computing devices and a processing unit that can be communicatively coupled to the interface. The interface can be configured to receive a first fingerprint of a first computing device. The first computing device may be associated with a first user, and the first fingerprint can provide an inventory of the first computing device. The inventory may include operational characteristics of the first computing device and information related to an identity of the first user.

The processing unit can be configured to determine first content to be delivered to the first computing device. The first content can be based on the received first fingerprint such that the first content is based on the operational characteristics of the first computing device and a profile that is established for the first user. Moreover, the interface can be configured to receive a second fingerprint of a second computing device that may also be associated with the first user. The second fingerprint may provide an inventory of the second computing device, and the inventory of the second computing device can include operational characteristics of the second computing device and information related to the identity of the first user. The processing unit can be further configured to determine second content to be delivered to the second computing device. The second content may be based on the received second fingerprint such that the second content is based on operational characteristics of the second computing device and the profile that is established for the first user.

The interface may be further configured to send the first content to the first computing device and to send the second content to the second computing device. As an example, the operational characteristics of the first or second computing device include one or more of the following: memory resources; processing capabilities; current version or type of operating system; installed applications; hardware assets and their characteristics; framework minimum and maximum deployment versions; or communication characteristics. As another example, the profile that is established for the first user may be based on an organizational function assigned to the first user. In one embodiment, the first computing device and the second computing device may include different operating systems, different software configurations or different hardware configurations.

Another system for automatic agnostic provisioning of a computing device is described herein. The system can include a processing unit and a memory unit in which the memory unit may be communicatively coupled to the processing unit. The processing unit can be configured to generate a profile that may establish a level of management and operation for a particular user, and the memory unit can be configured to store the profile. The processing unit can be further configured to identify a plurality of computing devices that are associated with the user and to tailor content to be delivered to the computing devices based on the characteristics of the computing devices and the generated profile such that a substantially consistent level of management and operation is maintained for the user across the plurality of computing devices dependent on the characteristics of the computing devices.

The system can further include an interface in which the interface is configured to deliver the content to the computing devices. In addition, the interface can be further configured to receive a fingerprint from each of the plurality of computing devices in which the fingerprint identifies the user and the characteristics of the computing devices. In one embodiment, the fingerprints may be received in a successive manner such that there is a measurable time difference between the receipt of the fingerprints. As an example, the profile that the processing unit generates for the user may be based on an organizational function assigned to the user. As another example, the content may include applications, setting or configurations that are to be applied to the computing devices.

Another system for automatic agnostic provisioning of a computing device is described herein. The system can include an interface that is configured to receive a first fingerprint of a computing device. The computing device may be associated with a user and the first fingerprint can provide a first inventory of the computing device. The first inventory may include operational characteristics of the computing device and information related to an identity of the user. The system can also include a processing unit that can be communicatively coupled to the interface, and the processing unit can be configured to determine first content to be delivered to the computing device. The first content may be based on the received first fingerprint such that the first content is based on the operational characteristics of the computing device and a profile that is established for the user.

The interface is further configured to receive an update fingerprint of the computing device in which the update fingerprint can provide an updated inventory of the computing device. The updated inventory of the computing device may include updated operational characteristics of the computing device. The processing unit can be further configured to determine updated content to be delivered to the computing device. The updated content is based on the received update fingerprint such that the updated content is based on the updated inventory and the profile that is established for the user.

As an example, the interface can be further configured to send the first content and the updated content to the computing device, and the updated inventory can further include information related to the user. As another example, the profile that is established for the user can be based on an organizational function assigned to the user.

A computing device is described herein. The computing device can include a transceiver and a processing unit that is communicatively coupled to the transceiver. The processing unit can be configured to generate a fingerprint that can provide an inventory of the computing device. The inventory can include operational characteristics of the computing device and information related to a user of the computing device. The transceiver can be configured to receive content that is based on the fingerprint such that the content is based on operational characteristics of the computing device and on a profile that has been established for the user. The processing unit can be further configured to generate an update fingerprint that provides an updated inventory of the computing device, and the inventory includes updated operational characteristics of the computing device. The transceiver can be further configured to receive updated content that is based on the update fingerprint and the profile of the user such that a predetermined level of management is maintained for the computing device if the computing device is updated.

As an example, the content and the updated content may include applications, configurations or settings. As another example, the operational characteristics of the computing device may include one or more of the following: memory resources; processing capabilities; current version or type of operating system; installed applications; hardware assets and their characteristics; framework minimum and maximum deployment versions; or communication characteristics. In one arrangement, the predetermined level of management can be maintained for the computing device if the computing device is updated with a software feature or a hardware feature.

A plurality of computing devices is also described herein. The plurality of computing devices can include a first computing device, which can have a transceiver and a processing unit that is communicatively coupled to the transceiver. The processing unit can be configured to generate a first fingerprint that can provide an inventory of the first computing device. The inventory can include operational characteristics of the first computing device and information related to a user of the first computing device. The transceiver can be configured to receive first content that is based on the first fingerprint such that the first content is based on operational characteristics of the first computing device and on a profile that has been established for the user.

The plurality of computing device can also include a second computing device that is associated with the user. The second computing device can include a transceiver and a processing unit that can be communicatively coupled to the transceiver. The processing unit can be configured to generate a second fingerprint that may provide an inventory of the second computing device. The inventory can include operational characteristics of the second computing device and information related to the user. The transceiver of the second computing device can be configured to receive second content that is based on the second fingerprint such that the second content is based on operational characteristics of the second computing device and on the profile that has been established for the user. A consistent management level that is associated with the user and the first computing device can be maintained for the second computing device, depending on the characteristics of the second computing device.

As an example, the first content and the second content can include applications, configurations and setting, and the first content may be different from the second content. The profile of the user can be based on an organizational function of the user.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for automatic agnostic provisioning of a computing device.

FIG. 2 illustrates an example of a computing device that may be part of the system of FIG. 1.

FIG. 3 illustrates an example of a method of automatic provisioning of a computing device that involves multiple computing devices.

FIG. 4 illustrates another example of a method of automatic provisioning of a computing device that involves updates of the computing device.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “computer program medium” and “computer readable medium” are defined as one or more components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions. The term “memory” or “memory unit” is defined as one or more components that are configured to store data, either on a temporary or persistent basis. An “interface” is defined as a component or a group of components that enable(s) a device to communicate with one or more different devices, whether through hard-wired connections, wireless connections or a combination of both. A “transceiver” is defined as a component or a group of components that transmit signals, receive signals or transmit and receive signals, whether wirelessly or through a hard-wired connection or both.

The term “agnostic provisioning” is defined as a process in which a user is provided with a substantially consistent user experience across various computing devices used by the user. The term “fingerprint” is defined as a representation of the inventory associated with a computing device that may be processed by some other component to determine the characteristics of the computing device. The term “operational characteristic” is defined as a feature that is related to the operation of a computing device and may include any combination of the following: the capabilities (both hardware and software) of the device, installed applications and other content on the device, configurations or settings of the device or information related to the identify of a user of the device. A “profile” is defined as a configuration of settings, parameters and/or arrangements that are associated with and determine a level of management and access for a particular person or group of persons. The term “content” is defined as material that may be delivered to a computing device to modify or maintain the operation of the computing device in some way, and non-limiting examples include applications, settings or configurations.

As explained earlier, the management of computing devices, such as mobile units, has become increasingly complicated in view of the large number of competing and varied products in the marketplace. In fact, once a first mobile unit has been provisioned for a particular user, that user may obtain a second mobile device that runs on a different operating system and includes different hardware features in comparison to the first unit. To accommodate this change, an administrator must manually intervene to ensure that the user is provided with the same level of service as before.

To address this issue, a method and system for automatic agnostic provisioning of a computing device is described herein. The method can include the steps of generating a profile that establishes a level of management and operation for a particular user and identifying a plurality of computing devices that are associated with the user. The method can also include the step of tailoring content to be delivered to the computing devices based on the characteristics of the computing devices and the generated profile such that a substantially consistent level of management and operation is maintained for the user across the plurality of computing devices dependent on the characteristics of the computing devices.

As such, a user may switch from a first provisioned device to a second device, and the second device may be automatically provisioned to ensure the user is provided with the same level of service as before with respect to the first device, dependent on the features of the second device. This principle may apply even if the first device and the second device have significant differences, such as different operating systems or hardware features.

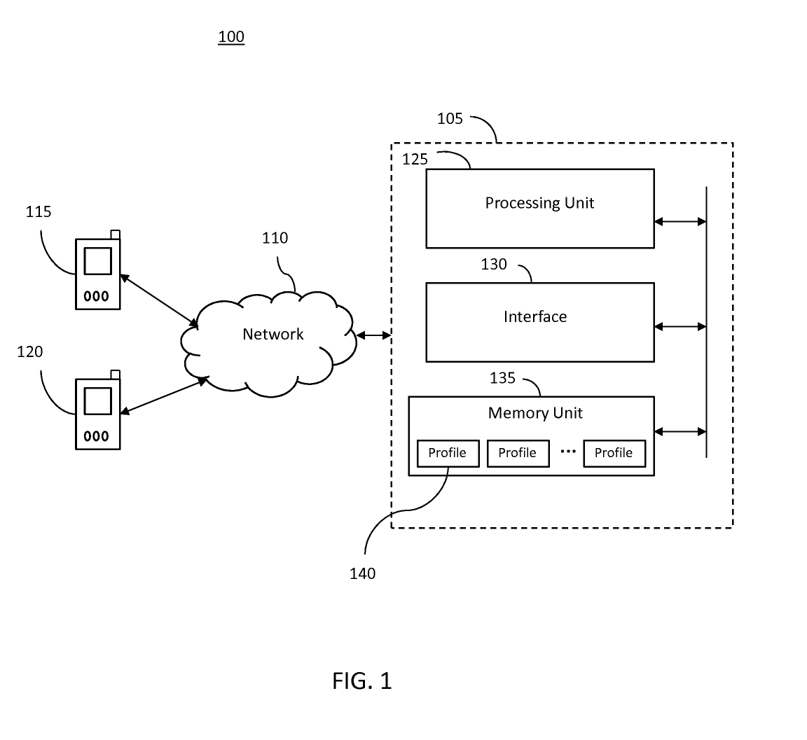

Referring to FIG. 1, a system 100 for automatic agnostic provisioning of a computing device is shown. The system 100 can include a provisioning module 105, a network 110, a first computing device 115 and a second computing device 120. The provisioning module 105 may be communicatively coupled to the network 110, and the devices 115, 120 may be communicatively coupled to the network 110. In one arrangement, the computing devices 115, 120 may be wireless devices, such as a smartphone or a laptop, although they may also be devices that are coupled to some hard-wired connection, such as a desktop computer or a server. Moreover, the network 110 may be comprised of any suitable combination of components to enable any type of wireless or wired communications. In fact, the network 110 may comprise multiple networks, each working in tandem to support communications between the computing devices 115, 120 and the provisioning module 105.

The provisioning module 105 may be any suitable combination of components to enable the provisioning and management of the computing devices 115, 120. For example, the module 105 may include a processing unit 125, an interface 130 and a memory unit 135, each of which may be communicatively coupled to one another. The interface 130 may cooperate with the network 110 or other suitable components to establish communications with the provisioning module 105 and the computing devices 115, 120. In addition, the processing unit 125 may execute instructions to carry out several processes, examples of which will be described later. The memory unit 135 may store any suitable type of data. One example of such data includes profiles 140 that may be established for users of the computing devices 115, 120. As will be explained below, these profiles may be helpful in determining the type of content that is to be delivered to the computing devices 115, 120.

In one arrangement, the computing devices 115, 120 may register with the provisioning module 105, and in response, the module 105 may send certain types of content to the devices 115, 120. For example, based on the user associated with the devices 115, 120, the provisioning module 105 may deliver a bundle (not shown) that includes applications, configurations or settings that are to be applied to the devices 115, 120. In one specific example, the delivered content may be based on an organizational function that is assigned to the user of the devices 115, 120.

Consider the following scenario. A user of the computing device 115 may be an employee of an enterprise, and the employee may have be assigned an organizational function for the enterprise, such as sales, legal, engineering, etc. This organizational function—and hence the delivered content—may be uniquely prepared for that user, or the user may be part of a group that receives substantially similar content. Thus, based on the type of work or function that a user performs for a certain organization, the organization may cause certain default content to be sent and applied to that user's computing device. As referenced earlier, this content may include applications, configurations and settings that are to be applied to the computing device 115 of the user.

Once applied, the user of the computing device 115 may have access to sensitive data related to the organization or some other entity. Moreover, the device 115 may allow IT administrators to manage the device 115 in certain ways, such as provisioning the device 115, controlling its inventory, supervising its network access, requiring minimum security settings for it, setting its policies and protecting its corporate data. Earlier presentations have been provided that illustrate a mobile device management solution that describes some of these techniques, such as in U.S. patent application Ser. No. 13/179,513, filed on Jul. 9, 2011, which is incorporated by reference herein in its entirety.

The type of content that is delivered to the computing device 115 may also depend on the characteristics or capabilities of the device 115. For example, if the device 115 does not support video conference calls, then the type of content to be provided to the device 115 may be adjusted accordingly. To assist in this process, the computing device 115 may provide an inventory of its characteristics to the provisioning module 105 when it registers with the module 105 or at any other suitable time. Examples of this feature will be presented below. As such, a level of management and operation associated with a user may depend on both the organizational function of that user and the type of computing device of the user.

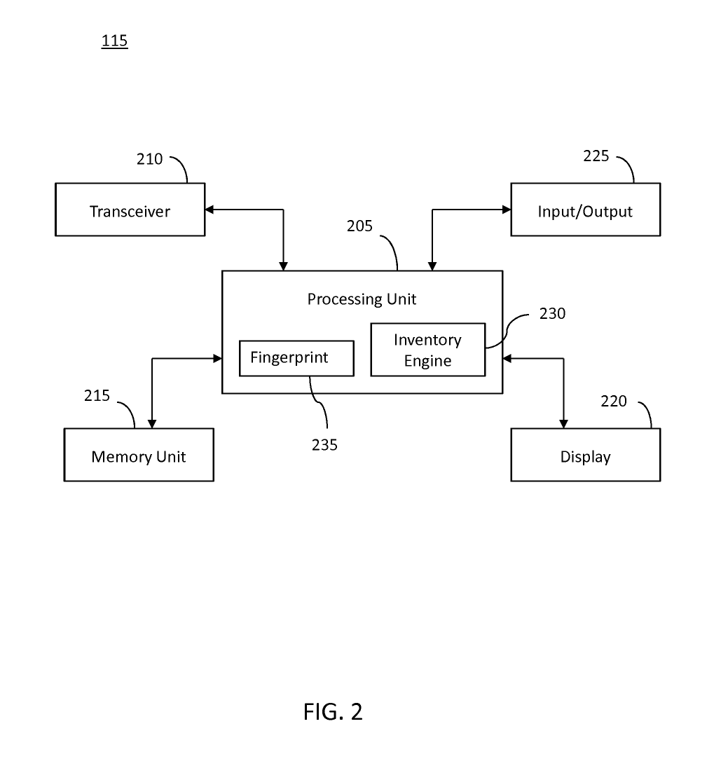

Referring to FIG. 2, an example of a block diagram of the computing device 115 of FIG. 1 is shown. This layout may also be applicable to the computing device 120 of FIG. 1. In one arrangement, the computing device 115 may include a processing unit 205, a transceiver 210, a memory unit 215, a display 220 and an input/output (I/O) mechanism 225, such as a keypad, speakers, microphones, cameras or other similar devices. The processing unit 205 may be communicatively coupled to each of these components and also may include an inventory engine 230. In another arrangement, the inventory engine 230 may be a component that is separate and distinct from the processing unit 205 but configured to exchange signals with the processing unit 205.

The transceiver 210 may be configured to communicate over a wired or wireless connection, and the memory unit 215 can include any combination of temporary or persistent storage and can store any suitable type of data. As an example, the display 220 may be a touch screen.

In one embodiment, as part of its registration with the provisioning module 105, the inventory engine 230 of the computing device 115 may conduct an inventory of the capabilities or operational characteristics of the device 115. Examples of these characteristics will be presented below. This inventory may also include information that is related to the identity of the user of the computing device 115. Once the inventory is complete, the processing unit 205 may generate a fingerprint 235 of the computing device 115, which can include information related to the inventory, and can cause the fingerprint 235 to be delivered to the provisioning module 105. The provisioning module 105 may use the fingerprint 235 to provision the computing device 115, as previously explained.

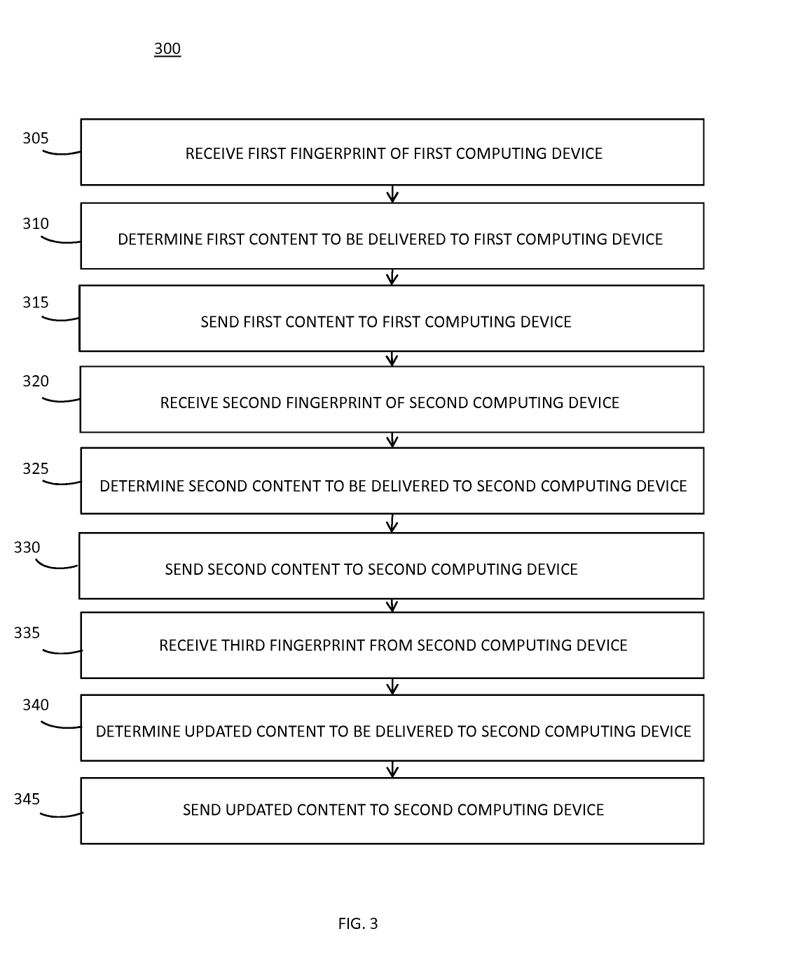

Referring to FIG. 3, a method 300 of automatic agnostic provisioning of a computing device is shown. It is important to note that the method 300 may include additional or even fewer steps or processes in comparison to what is illustrated in FIG. 3. Moreover, the method 300 is not necessarily limited to the chronological order that is shown in FIG. 3. In describing the method 300, reference may be made to FIGS. 1 and 2, although it is understood that the method 300 may be practiced with any other suitable systems and components.

At step 305, a first fingerprint of a first computing device may be received, and at step 310, first content to be delivered to the first computing device may be determined. At step 315, the first content may be sent to the first computing device.

For example, a first fingerprint 235 may be received at the provisioning module 105 from the computing device 115, and the computing device 115 may be associated with a first user. The user may be an employee or an associate of an enterprise or some other organization, and the organization may establish a profile 140 for the first user, which can be stored in the memory unit 135 or some other location. The profile 140 may include, for example, information that is based on the first user's organizational function in the organization. As a specific but non-limiting example, the first user may be a salesman for an enterprise, and the enterprise may generate information—such as applications related to travel or calendaring and device settings to ensure secure connections are employed—to be applied to the computing device 115. As explained earlier, the profile 140 may be unique to the first user, or it may be applicable to a group of users.

As noted earlier, the first fingerprint 235 may provide an inventory of the computing device 115, which can include the operational characteristics of the device 115. Non-limiting examples of some of the operational characteristics that are part of the inventory may include one or more of the following: (1) memory resources, such as the capacity (total and in use) of the memory unit 215; (2) processing capabilities, such as the processing power of the processing unit 205 or other similar components; (3) current version or type of operating system; (4) installed applications or programs on the device 115; (5) hardware assets of the device 115 and characteristics of those assets, such as the existence of cameras and their resolution and frame rates (if applicable), whether the display 220 is a touch screen, whether the I/O mechanism 225 includes an array of speakers or microphones or the existence of any supported peripherals; (6) framework minimum and maximum deployment versions, such as enforcement of system version compatibility for upgrades or downgrades of applications; or (7) communication characteristics, such as the type of communications that are supported by the computing device 115 and download and upload speeds. It is understood that this listing is not meant to be exhaustive, as other characteristics of a computing device may be part of the fingerprint for that device.

Because the first fingerprint 235 may include information related to the first user, the provisioning module 105 may access the profile 140 and determine the first content that should be delivered to the computing device 115. This determination, however, may also be based on the operational characteristics of the computing device 115, as gleaned from the received first fingerprint 235. Thus, for example, when determining the content that is to be delivered to the computing device 115, the processing unit 125 may selectively remove items that do not apply or that are not relevant to the computing device 115 in view of the operating characteristics of the device 115 but that normally would be selected for such delivery based on the profile 140 of the first user. For example, the profile 140 of the user may call for a video conferencing application to be part of the content for the computing device 115. The first fingerprint 235 of the computing device 115, however, may reveal that the computing device 115 does not support video conferencing. At this point, the processing unit 125 of the provisioning module 105 may determine that the video conferencing application is not to be part of the content to be delivered to the computing device 115. Items in the profile 140 that are relevant to the computing device 115, however, may remain as part of the content to be delivered.

Although the profile 140 and the operating characteristics determine the content to be delivered, the description here is not necessarily so limited. For example, other factors may play a part in the determination of the content, such as bandwidth/capacity of networks that support the provisioning module 105 and the computing device 115, the number of users supported by the provisioning module 105 or the expense involved in delivering the content to the computing device 115. Of course, these factors may play a part in the generation of the profile 140 for a particular user or a group of users, as well. In any event, it must be understood that there are numerous considerations that may play a part in determining the content to be delivered to a computing device.

Once the content is finalized, the provisioning module 105 may send the content to the computing device 115, and the content may be applied to the device 115. For example, a secure workspace may be generated on the computing device 115 and certain applications (secure or non-secure) may be installed on the computing device 115. As another example, certain settings may be imposed on the device 115, such as a restriction that the device 115 is limited to communications over secure networks or that some data must be encrypted and stored remotely. Additional management techniques for the computing device 115 and applications—including secure applications—that are stored thereon may be found in U.S. Patent Application Publication No. 2012/0036552, filed on Jul. 9, 2011, and U.S. patent application Ser. No. 13/626,470, filed on Sep. 25, 2012, each of which is incorporated herein by reference in its entirety.

Referring once again to the method 300, at step 320, a second fingerprint of a second computing device may be received. At step 325, second content to be delivered to the second computing device can be determined, and the second content can be sent to the second computing device, as shown at step 330.

For example, a second fingerprint 235 can be received at the provisioning module 105 from a second computing device 120. The second computing device 120 may also be associated with the first user. There are several exemplary circumstances that may lead to this scenario. In particular, the first user may have decided to upgrade from the first computing device 115 to a newer model, or the first user may have lost the first computing device 115 or have had it stolen. In these examples, the second computing device 120 may be a separate and distinct unit in relation to the first computing device 115. As another example, the second computing device 120 may even include a different operating system or different hardware or software configurations in comparison to the first computing device 115.

In any event, the second fingerprint 235 may provide an inventory of the second computing device 120. This inventory can include operational characteristics of the second computing device 120 and information related to the identity of the first user, similar to the process described above in relation to the first fingerprint 235. In addition, the processing unit 125 can determine second content to be delivered to the second device 120 based on the operational characteristics of the second device 120 and the profile 140 of the first user, like the process described above. In this case, the processing unit 125 can take into account any differences that may exist between the first computing device 115 and the second computing device 120. For example, the second device 120 may support video conferencing, a feature that may not have been available on the first device 115. Going further, the profile 140 of the first user, which may not have changed in this example, may still call for a video conferencing application to be part of content that is to be delivered to a computing device associated with the first user. As such, the processing unit 125 may determine that the second content for the second computing device 120 is to include an application that employs or enhances video conferencing, whereas this application may have been removed from the first content for the first computing device 115. This principle may apply to numerous items that comprise the profile 140 of the first user. As such, the level of management, operation and access to information for the first user may be substantially and consistently maintained for the first user across a plurality of computing devices, depending on the capabilities or characteristics of the computing devices. That is, content can be tailored to be delivered to a plurality of computing devices based on the characteristics or capabilities of these devices and a generated profile of a user as the user successively activates the computing devices. The processing unit 125 of the provisioning module 105 can be further configured to successively identify the plurality of computing devices such that some time exists between identifications of the computing devices. For example, each new computing device that the user acquires may be successively identified and provisioned, in accordance with the above description.

Once the second content is finalized, it can be delivered and applied to the second computing device 120. At this point, the first user—through the second computing device—may still have access to all the applications and other information that his/her profile authorizes, so long as the second device 120 supports such content.

Referring back to FIG. 3, at step 335, a third fingerprint can be received from the second computing device, and updated content to be delivered to the second computing device can be determined, as shown at step 340. The updated content can be sent to the second computing device, as shown at step 345.

For example, the capabilities or characteristics of the second computing device 120 may be updated in some way, which may include new or improved hardware or software features. As a specific but non-limiting example, the second device 120 might be updated with a new operating system or may have installed new applications or other programs. As another non-limiting example, the second device 120 may have established a connection with a peripheral device, or the user may have installed additional memory for the second device 120. In either event, the second device 120 may now be able to operate in a way that was not possible before.

To accommodate these new features, the second computing device 120 may generate an update fingerprint 235, which can provide an updated inventory of the second device 120. The provisioning module 105 can receive the update fingerprint 235 and can determine these new features through the updated inventory. If necessary, the update fingerprint 235 may also include information related to the first user of the second device 120. At this point, the provisioning module 105 can determine whether updated content should be sent to the second computing device 120, and this determination can be based on the profile 140 of the first user and the new characteristics of the second device 120, similar to the description presented above.

The second computing device 120 may be updated multiple times over the course of its use by the first user. Each of these updates may or may not trigger the second device 120 to send an update fingerprint 235 to the provisioning module 105. For example, the processing unit 205 of the second computing device 120 may be configured to only generate update fingerprints 235 if the update reaches a predetermined threshold or affects a predetermined listing of functions, configurations or settings. Moreover, the timing of when an update fingerprint 235 is sent to the provisioning module 105 can be based on a periodic interval or based on an event, such as the update itself. If desired, fingerprints 235 may be periodically transmitted to the module 105 even if they contain no new information in comparison to a previous fingerprint 235.

Although the examples described above focus primarily on a first user switching computing devices, the description herein is not so limited. For example, an event may have occurred that has resulted in the first user having a new profile 140. The profile 140 may change, for example, if the first user has switched positions in a particular organization, and the organizational function of the first user may have changed, such as the first user switching from a sales position to an administrative one. This change may necessitate the addition of and/or removal of items from the first user's profile. For example, applications that are related to a sales function may be removed from the profile 140, while those related to office productivity may be added to it. The change in this profile 140 may prompt the provisioning module 105 to provide updated content to the computing device at or near the time the modification occurs. In another arrangement, the change to the content to be delivered to the computing device may be effected when an update fingerprint 235 is received from the computing device.

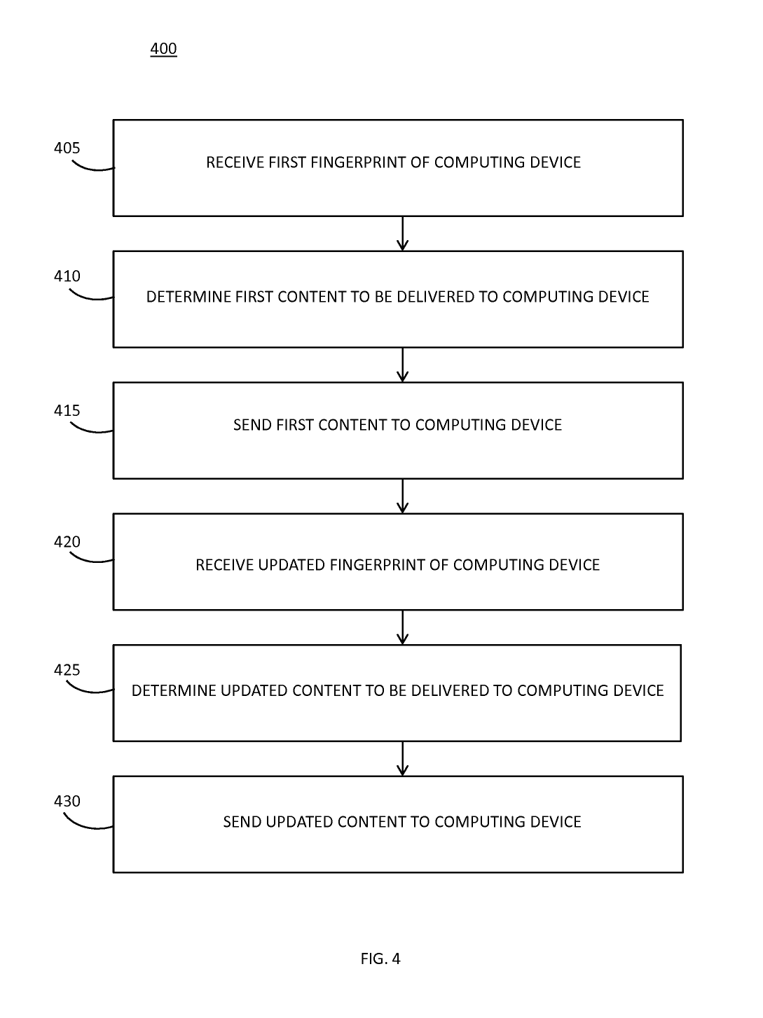

Referring to FIG. 4, another method 400 for automatic agnostic provisioning of a computing device is shown. It is important to note that the method 400 may include additional or even fewer steps or processes in comparison to what is illustrated in FIG. 4. Moreover, the method 400 is not necessarily limited to the chronological order that is shown in FIG. 4. In describing the method 400, reference may be made to FIGS. 1 and 2, although it is understood that the method 400 may be practiced with any other suitable systems and components.

At step 405, a first fingerprint of a computing device may be received, and at step 410, first content to be delivered to the computing device can be determined. At step 415, the first content can be delivered to the computing device. An update fingerprint of the computing device can be received, as shown at step 420, and at step 425, updated content to be delivered to the computing device can be determined. At step 430, the updated content can be sent to the computing device.

The method 400 is intended to show that the techniques described herein may also apply to a single computing device. In particular, the first user may be associated with the first computing device 115, and the provisioning module 105 may receive a first fingerprint 235 from the first device 115, which may provide a first inventory of the first device 115 that includes operational characteristics of the first device 115 and information related to the identity of the first user. As previously explained, the processing unit 125 of the provisioning module 105 may determine first content to be delivered to the first device 115 based on the operational characteristics of the first device 115 and the profile 140 of the first user. Once set, this first content may be sent and applied to the first device 115.

Eventually, the first computing device 115 may be updated in some way, such as being implemented with a new hardware or software feature. In accordance with previous descriptions, the first device 115 can send an update fingerprint 235 to the provisioning module 105, which can provide an updated inventory that includes updated operational characteristics of the first device 115. If necessary, the updated inventory can also include information related to the identity of the first user. The update fingerprint 235 may be sent based on a predetermined periodicity or a predetermined event. The provisioning module 105 can then determine updated content to be sent to the first computing device 115 based on the updated inventory and the profile 140 of the user. The updated content can then be delivered to the first computing device 115. As such, content can be tailored to a computing device based on the characteristics of the device and the profile of the user such that a substantially consistent level of management, access and operation can be maintained for the user of the device, dependent on the updated characteristics of the device. These principles may continue to be applied to the first device if the user maintains his/her association with the first device and are not necessarily dependent on the user switching computing devices. It is also important to note that any changes to the profile of the user may also be applied to the content to be delivered to the first computing device in this situation, similar to the process illustrated above.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of automatic agnostic provisioning of a computing device, comprising:
receiving a first fingerprint of a first computing device, wherein the first computing device is associated with a first user and the first fingerprint provides an inventory of the first computing device and the inventory includes operational characteristics of the first computing device and information related to an identity of the first user;
determining first content to be delivered to the first computing device, wherein the first content is based on the received first fingerprint such that the first content is based on the operational characteristics of the first computing device and a profile that is established for the first user;
sending the first content to the first computing device;
receiving a second fingerprint of a second computing device that is also associated with the first user, wherein the second fingerprint provides an inventory of the second computing device and the inventory of the second computing device includes operational characteristics of the second computing device and information related to the identity of the first user;
determining second content to be delivered to the second computing device, wherein the second content is based on the received second fingerprint such that the second content is based on operational characteristics of the second computing device and the profile that is established for the first user; and
sending the second content to the second computing device.

2. The method according to claim 1, wherein the operational characteristics of the first or second computing device include one or more of the following: memory resources; processing capabilities; current version or type of operating system; installed applications; hardware assets and their characteristics; framework minimum and maximum deployment versions; or communication characteristics.

3. The method according to claim 1, wherein the profile that is established for the first user is based on an organizational function assigned to the first user.

4. The method according to claim 1, wherein the first computing device includes a first operating system and the second computing device includes a second operating system.

5. The method according to claim 1, further comprising receiving a third fingerprint from the second computing device, wherein the third fingerprint provides an updated inventory of the second computing device.

6. The method according to claim 5, further comprising receiving the third fingerprint on a periodic basis or based on an event.

7. The method according to claim 6, further comprising:
determining updated content to be delivered to the second computing device, wherein the updated content is based on the received third fingerprint; and
sending the updated content to the second computing device;
wherein the updated content is based on operational characteristics of the second computing device and the profile that is established for the first user.

8. The method according to claim 1, wherein the first content and the second content includes applications, settings or configurations that are to be applied to the first and second computing devices.

9. A method for automatic agnostic provisioning of a computing device, comprising:
sending a first fingerprint of a first computing device, wherein the first computing device is associated with a first user and the first fingerprint provides an inventory of the first computing device and the inventory includes operational characteristics of the first computing device and information related an identity of the first user;
receiving first content at the first computing device, wherein the first content is based on the first fingerprint such that the first content is based on the operational characteristics of the first computing device and a profile that is established for the first user;
sending a second fingerprint of a second computing device that is also associated with the first user, wherein the second fingerprint provides an inventory of the second computing device and the inventory of the second computing device includes operational characteristics of the second computing device and information related to the identity of the first user; and
receiving second content at the second computing device, wherein the second content is based on the received second fingerprint such that the second content is based on operational characteristics of the second computing device and the profile that is established for the first user.

10. The method according to claim 9, wherein the profile that is established for the first user is based on an organizational function assigned to the first user.

11. The method according to claim 9, wherein the first and second computing devices include different operating systems.

12. A method of automatic agnostic provisioning of a computing device, comprising:
generating a profile that establishes a level of management and operation for a particular user;
identifying a plurality of computing devices that are associated with the user; and
tailoring content to be delivered to the computing devices based on the characteristics of the computing devices and the generated profile such that a substantially consistent level of management and operation is maintained for the user across the plurality of computing devices dependent on the characteristics of the computing devices.

13. The method according to claim 12, further comprising receiving a fingerprint from each of the plurality of computing devices, wherein the fingerprint identifies the user and the characteristics of the computing devices.

14. The method according to claim 13, further comprising:
receiving an update fingerprint for one of the computing devices; and
sending update content to the computing device from which the update fingerprint was received.

15. The method according to claim 13, wherein the characteristics of the computing devices include one or more of the following: memory resources; processing capabilities; current version or type of operating system; installed applications; hardware assets; framework minimum and maximum deployment versions; or communication characteristics.

16. The method according to claim 12, wherein the profile that is generated for the user is based on an organizational function assigned to the user.

17. The method according to claim 12, wherein the content includes applications, settings or configurations that are to be applied to the computing devices.

18. The method according to claim 12, wherein identifying the plurality of computing devices that are associated with the user comprises successively identifying the plurality of computing devices such that some time exists between identifications of the computing devices.

19. A method of automatic agnostic provisioning of a computing device, comprising:
receiving a first fingerprint of a computing device, wherein the computing device is associated with a user and the first fingerprint provides a first inventory of the computing device and the first inventory includes operational characteristics of the computing device and information related to an identity of the user;
determining first content to be delivered to the computing device, wherein the first content is based on the received first fingerprint such that the first content is based on the operational characteristics of the computing device and a profile that is established for the user;
sending the first content to the computing device;
receiving an update fingerprint of the computing device, wherein the update fingerprint provides an updated inventory of the computing device and the updated inventory of the computing device includes updated operational characteristics of the computing device;
determining updated content to be delivered to the computing device, wherein the updated content is based on the received update fingerprint such that the updated content is based on the updated inventory and the profile that is established for the user; and
sending the updated content to the computing device.

20. The method according to claim 19, wherein the updated inventory further includes information related to the identity of the user.

21. The method according to claim 19, wherein the profile that is established for the user is based on an organizational function assigned to the user.

22. The method according to claim 19, wherein the update fingerprint is received based on a predetermined periodicity or based on a predetermined event.

23. A method of automatic agnostic provisioning of a computing device, comprising:
generating a profile that establishes a level of management and operation for a particular user;
identifying a computing device that is associated with the user; and
tailoring content to be delivered to the computing device based on the characteristics of the computing device and the generated profile such that a substantially consistent level of management and operation is maintained for the user for the computing device when the computing device is updated, dependent on updated characteristics of the computing device.

24. The method according to claim 23, wherein the updated characteristics are related to updated software features or updated hardware features.

25. A system for automatic agnostic provisioning of a computing device, comprising:
an interface that is configured to receive communications from and transmit communications to a plurality of computing devices; and
a processing unit, wherein the processing unit is communicatively coupled to the interface;
wherein the interface is configured to receive a first fingerprint of a first computing device, wherein the first computing device is associated with a first user and the first fingerprint provides an inventory of the first computing device and the inventory includes operational characteristics of the first computing device and information related to an identity of the first user;
wherein the processing unit is configured to determine first content to be delivered to the first computing device, wherein the first content is based on the received first fingerprint such that the first content is based on the operational characteristics of the first computing device and a profile that is established for the first user;
wherein the interface is further configured to receive a second fingerprint of a second computing device that is also associated with the first user, wherein the second fingerprint provides an inventory of the second computing device and the inventory of the second computing device includes operational characteristics of the second computing device and information related to the identity of the first user;
wherein the processing unit is further configured to determine second content to be delivered to the second computing device, wherein the second content is based on the received second fingerprint such that the second content is based on operational characteristics of the second computing device and the profile that is established for the first user.

26. The system according to claim 25, wherein the interface is further configured to send the first content to the first computing device and to send the second content to the second computing device.

27. The system according to claim 25, wherein the operational characteristics of the first or second computing device include one or more of the following: memory resources; processing capabilities; current version or type of operating system; installed applications; hardware assets and their characteristics; framework minimum and maximum deployment versions; or communication characteristics.

28. The system according to claim 25, wherein the profile that is established for the first user is based on an organizational function assigned to the first user.

29. The system according to claim 25, wherein the first computing device and the second computing device include different operating systems, different software configurations or different hardware configurations.

30. A system for automatic agnostic provisioning of a computing device, comprising:
a processing unit; and
a memory unit, wherein the memory unit is communicatively coupled to the processing unit;
wherein the processing unit is configured to generate a profile that establishes a level of management and operation for a particular user and the memory unit is configured to store the profile;
wherein the processing unit is further configured to:
identify a plurality of computing devices that are associated with the user; and
tailor content to be delivered to the computing devices based on the characteristics of the computing devices and the generated profile such that a substantially consistent level of management and operation is maintained for the user across the plurality of computing devices dependent on the characteristics of the computing devices.

31. The system according to claim 30, further comprising an interface, wherein the interface is configured to deliver the content to the computing devices.

32. The system according to claim 31, wherein the interface is further configured to receive a fingerprint from each of the plurality of computing devices, wherein the fingerprint identifies the user and the characteristics of the computing devices.

33. The system according to claim 31, wherein the fingerprints are received in a successive manner such that there is a measurable time difference between the receipt of the fingerprints.

34. The system according to claim 30, wherein the profile that the processing unit generates for the user is based on an organizational function assigned to the user.

35. The system according to claim 30, wherein the content includes applications, setting or configurations that are to be applied to the computing devices.

36. A system for automatic agnostic provisioning of a computing device, comprising:
an interface, wherein the interface is configured to receive a first fingerprint of a computing device, wherein the computing device is associated with a user and the first fingerprint provides a first inventory of the computing device and the first inventory includes operational characteristics of the computing device and information related to an identity of the user; and
a processing unit, wherein the processing unit is communicatively coupled to the interface and the processing unit is configured to determine first content to be delivered to the computing device, wherein the first content is based on the received first fingerprint such that the first content is based on the operational characteristics of the computing device and a profile that is established for the user;
wherein the interface is further configured to receive an update fingerprint of the computing device, wherein the update fingerprint provides an updated inventory of the computing device and the updated inventory of the computing device includes updated operational characteristics of the computing device;
wherein the processing unit is further configured to determine updated content to be delivered to the computing device, wherein the updated content is based on the received update fingerprint such that the updated content is based on the updated inventory and the profile that is established for the user.

37. The system according to claim 36, wherein the interface is further configured to send the first content and the updated content to the computing device.

38. The system according to claim 36, wherein the updated inventory further includes information related to the user.

39. The system according to claim 36, wherein the profile that is established for the user is based on an organizational function assigned to the user.

40. A computing device, comprising:
a transceiver; and
a processing unit that is communicatively coupled to the transceiver;
wherein the processing unit is configured to generate a fingerprint that provides an inventory of the computing device and the inventory includes operational characteristics of the computing device and information related to a user of the computing device;
wherein the transceiver is configured to receive content that is based on the fingerprint such that the content is based on operational characteristics of the computing device and on a profile that has been established for the user;
wherein the processing unit is further configured to generate an update fingerprint that provides an updated inventory of the computing device and the inventory includes updated operational characteristics of the computing device;
wherein the transceiver is further configured to receive updated content that is based on the update fingerprint and the profile of the user such that a predetermined level of management is maintained for the computing device if the computing device is updated.

41. The computing device according to claim 40, wherein the content and the updated content includes applications, configurations or settings.

42. The computing device according to claim 40, wherein the operational characteristics of the computing device include one or more of the following: memory resources; processing capabilities; current version or type of operating system; installed applications; hardware assets and their characteristics; framework minimum and maximum deployment versions; or communication characteristics.

43. The computing device according to claim 40, wherein the predetermined level of management is maintained for the computing device if the computing device is updated with a software feature or a hardware feature.

44. A plurality of computing devices, comprising:
a first computing device, comprising:
a transceiver; and
a processing unit that is communicatively coupled to the transceiver;
wherein the processing unit is configured to generate a first fingerprint that provides an inventory of the first computing device and the inventory includes operational characteristics of the first computing device and information related to a user of the first computing device;
wherein the transceiver is configured to receive first content that is based on the first fingerprint such that the first content is based on operational characteristics of the first computing device and on a profile that has been established for the user; and
a second computing device that is associated with the user, comprising:
a transceiver; and
a processing unit that is communicatively coupled to the transceiver;
wherein the processing unit is configured to generate a second fingerprint that provides an inventory of the second computing device and the inventory includes operational characteristics of the second computing device and information related to the user;
wherein the transceiver is configured to receive second content that is based on the second fingerprint such that the second content is based on operational characteristics of the second computing device and on the profile that has been established for the user;
wherein a consistent management level that is associated with the user and the first computing device is maintained for the second computing device, depending on the characteristics of the second computing device.

45. The computing devices according to claim 44, wherein the first content and the second content include applications, configurations and settings.

46. The computing devices according to claim 45, wherein the first content is different from the second content.

47. The computing devices according to claim 44, wherein the profile of the user is based on an organizational function of the user.
